(19) United States
(12) Patent Application Publication
(10) Pub. No.: US 2013/0111225 A1
(43) Pub. Date: May 2, 2013

(54) POWER SUPPLIES WITH LAGGING POWER-FACTOR

(71) Applicants: Daniel Humphrey, Cypress, TX (US); Mohamed Amin Bemat, Cypress, TX (US); Mark Rivera, Cypress, TX (US)

(72) Inventors: Daniel Humphrey, Cypress, TX (US); Mohamed Amin Bemat, Cypress, TX (US); Mark Rivera, Cypress, TX (US)

(21) Appl. No.: 13/283,940

(22) Filed: Oct. 28, 2011

(51) Int. Cl. G06F 1/26; H02M 7/06

(52) U.S. Cl. 713/300; 363/126

(57) ABSTRACT

Apparatus related to power factor are provided. A power supply provides regulated power to a load or loads. The power supply is coupled to a source of alternating-current (AC) voltage. A controller monitors the AC input voltage and a current loading of the power supply. The controller determines an activation time according to the monitoring and asserts a signal prior to a next zero crossing of the input voltage. The signal causes impedance circuitry to be coupled between a pair of input nodes, resulting in a lagging power-factor. The impedance circuitry is de-coupled from at least one of the input nodes after the zero crossing.

### BACKGROUND

Power supplies are used to provide conditioned electrical energy to various loads within a data center such as computers, file servers, and the like. Some such power supplies include switching-type voltage boosting, which generates electrical noise (EMI) that must be filtered. EMI filtering often results in undesirable leading power-factors that can cause a number of other problems. The present teachings address the foregoing and other concerns.

### BRIEF DESCRIPTION OF THE DRAWINGS

The present embodiments will now be described, by way of example, with reference to the accompanying drawings, in which:

FIG. 1 depicts a system having a power supply according to one example of the present teachings;

FIG. 2 depicts a power supply with lagging power-factor adjustment according to another example;

FIG. 3 depicts a block diagram of a controller according to another example;

FIG. 4 depicts a schematic diagram of impedance circuitry according to another example;

FIG. 5 depicts a flow diagram of a method according to another example;

FIG. 6A depicts a signal diagram according to another example of the present teachings;

FIG. 6B depicts details of a lagging power-factor event in accordance with the signal diagram of FIG. 6A.

### DETAILED DESCRIPTION

### Introduction

Apparatus related to power factor are provided. A power supply provides regulated power to a load or loads. The power supply is coupled to a source of alternating-current (AC) voltage. A controller monitors the AC input voltage and a current loading of the power supply. The controller determines an activation time according to the monitoring and asserts or pulses a control signal prior to a next zero crossing event of the input voltage. The control signal triggers a switching element such that impedance circuitry is coupled between a pair of input nodes, resulting in a lagging power-factor.

The impedance circuitry is then de-coupled from at least one of the input nodes after the zero crossing, effectively isolating it from the rest of the power supply. The controller monitors the AC input voltage and the current loading and triggers operation of the impedance circuitry in accordance with each successive zero crossing event in an ongoing manner.

In one example, an apparatus includes circuitry characterized by impedance and a switching element. The switching element is configured to electrically couple the circuitry to at least one input node of a power supply in response to a control signal. The apparatus also includes a controller configured to determine a correction time in accordance with an alternating-current input voltage and a loading of a power supply. The controller is also configured to provide the control signal in accordance with the correction time.

In another example, a power supply includes a pair of input nodes to be coupled to a source of alternating-current electrical voltage. The power supply also includes circuitry characterized by impedance. The circuitry is configured to cause a lagging power-factor of the power supply. The power supply also includes a switch configured to electrically couple the circuitry to at least one of the input nodes in response to a control signal. The power supply further includes a controller configured to determine a trigger time in accordance with an input voltage and a current loading of the power supply. The controller is configured to provide the control signal in accordance with the trigger time.

In yet another example, a controller for use with a power supply is configured to determine an activation time in accordance with one or more sensed electrical variables of the power supply. The activation time corresponds to a next zero crossing of an input voltage to the power supply. The controller is also configured to assert a control signal in accordance with the activation time.

### First Illustrative System

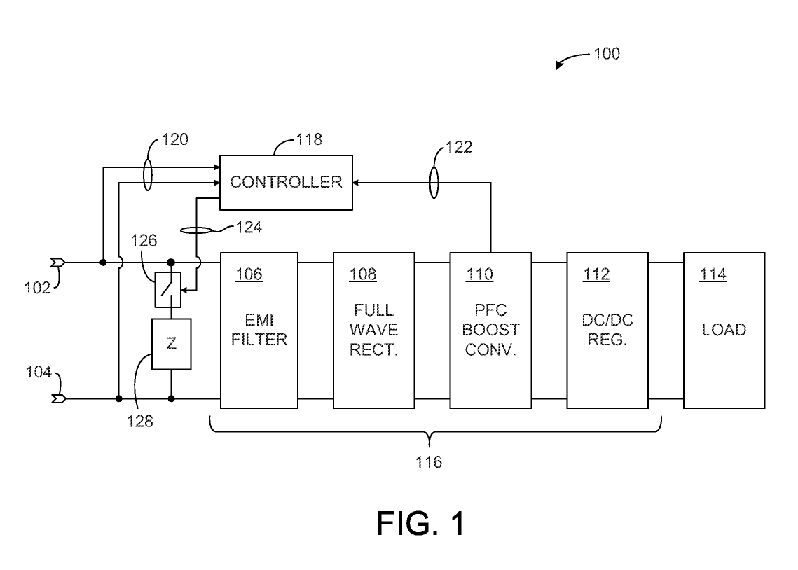

Reference is now made to FIG. 1, which depicts a system 100. The system 100 is illustrative and non-limiting in nature. Thus, other devices, apparatus and systems are contemplated by the present teachings.

The system 100 includes a pair of input nodes 102 and 104, respectively. The input nodes 102 and 104 are configured to be coupled to a source of alternating-current (AC) electrical energy or voltage. Such sources can include, for non-limiting example, a utility line-level source, an on-site generator or power conditioner, a solar energy system including a power inverter, and so on.

The system 100 also includes an electromagnetic interference (EMI) filter 106. The EMI filter 106 receives electrical energy from the input nodes 102 and 104, and is configured to attenuate (or filter) electrical noise that would otherwise be coupled back to the source of electrical energy. In one example, the EMI filter 106 is defined by capacitive and inductive (i.e., reactive) circuitry, with capacitance being the predominant characteristic. Such an EMI filter 106 tends to cause an undesirable leading power-factor (i.e., current leads voltage at zero-crossings).

The system 100 also includes a full-wave bridge rectifier (rectifier) 108. The rectifier 108 receives electrical energy by way of the EMI filter 106 and provides a fully rectified electrical voltage output (i.e., pulsating direct-current). The rectifier 108 can be defined by an integrated (unitary) rectifier, a circuit of plural discrete rectifier diodes, and so on. Other suitable embodiments of rectifier 108 can also be used.

The system 100 further includes a power-factor correction boost converter (converter) 110. The converter 110 receives rectified electrical energy from the rectifier 108 and provides (or generates) a direct-current (DC) output of greater voltage than the peak voltage which is received from the rectifier 108. Generally, the converter 110 is defined by switching-type boost converter circuitry that derives an increased DC voltage by way of energy storage and release through an inductive element. Other converter 110 topologies can also be used.

The system 100 also includes a DC-to-DC voltage regulator (regulator) 112. The regulator 112 receives the increased (i.e., boosted) DC voltage from the converter 110 and provides a conditioned DC voltage output. Non-limiting examples of such conditioning include constant-voltage regulation, current limiting, and the like. The regulator 112 can perform other types of electrical energy conditioning, as well. In one example, the regulator 112 is defined by a modular (i.e., unitary) voltage regulator as available from numerous commercial sources. Other regulators 112 can also be used.

The system 100 also includes an electrical load 114. The load 114 can include or be defined by a computer or plurality of computers, a file server or plurality of file servers, a blade-type server system, and so on. Other suitable loads 114 can also be defined and used. For purposes of non-limiting illustration, the load 114 is defined by a plurality of servers within a data center.

The elements 106-112, inclusive, collectively define a power supply 116. The power supply 116, as a whole, is configured to receive AC electrical energy from the input nodes 102 and 104 and to provide regulated (or conditioned) electrical energy to the load 114. The input nodes 102 and 104 can also be considered a portion or characteristic of the power supply 116.

However, as discussed above, the power supply 116 is characterized by a leading power-factor that can have undesirable effects during typical normal operations. Non-limiting examples of such undesirable effects include control loop problems, component or device de-rating, over-stressed circuit or system components, and/or an inability for certain elements or devices to operate at all.

The system 100 also includes a controller 118. The controller 118 can include, without limitation, a microprocessor, a microcontroller, a state machine, digital or analog or hybrid circuitry, an application-specific integrated circuit (ASIC), and so on. Other constituency can also be used. The controller 118 is configured to receive a signal 120 representing an AC input voltage at nodes 102 and 104. The controller 118 is also configured to receive a signal 122 from the converter 110 representing a current loading of the power supply 116.

The controller 118 is further configured to determine an activation time (or times) for adjusting the power-factor of the power supply 116. Specifically, the controller 118 uses the sensed signals 120 and 122 to determine when to enable impedance circuitry so as to cause an overall lagging power-factor for the system 100. The controller 118 is additionally configured to provide or assert a control signal 124 in accordance with the determined activation time. Additional discussion of this operation is provided below. Activation time(s) is/are also referred to as correction time(s) or trigger time(s) for purposes herein.

The system 100 also includes a switch or switchable element 126 and impedance circuitry (circuitry) 128. The switch 126 is configured to electrically couple the circuitry 128 to the node 102 in response to the control signal 124. In one example, the switch 126 is defined by or includes a triac-type thyristor device that is triggered into electrical conduction by the control signal 124, and which inherently drops out of electrical conduction during a zero crossing of the AC current there through. Other types of switching device can also be used.

The circuitry 128 is coupled to the switch 126 and to the node 104. The circuitry 128 is characterized by electrical impedance (“Z”) by virtue of one or more electrically reactive elements. In one example, the circuitry 128 is predominantly inductive in character. The circuitry 128 can be defined by any suitable electrical circuitry defined and configured in accordance with the particular characteristics of the power supply 116 and the lagging power-factor effect to be performed.

Typical, normal operations of the system 100 are generally as follows: AC electrical energy, characterized by a peak (or RMS) voltage, is received at the nodes 102 and 104. The AC electrical voltage is further characterized by a sine-wave frequency of, for non-limiting example, 50 Hertz or 60 Hertz.

The power supply 116 receives this AC electrical energy, filters and rectifies it (i.e., 106 and 108), boosts the voltage by switching conversion (i.e., 110), and provides conditioned or regulated electrical energy (i.e., 112) to a computer-based load 114. These operations would normally result in a leading power-factor, but for additional operations described immediately below.

The controller 118 monitors signals 120 (input voltage) and 122 (load current) and determines when to activate operation of the impedance circuitry 128. In particular, the controller 118 determines a time just before a next zero crossing of the AC input voltage at the nodes 102 and 104, and asserts the control signal 124 accordingly. The assertion of the control signal 124 causes the switch 126 to toggle to an electrically conductive state (i.e., “on”).

The conductive state of the switch 126 couples the circuitry 128 to the input node 102 and into parallel circuit relationship with the power supply 116. The electrically reactive characteristics of the circuitry 128 cause the overall power-factor to be lagging in nature (current lags voltage).

The state of the switch 126 is then toggled back to a non-conductive state (i.e., “off”) at some time just after the zero crossing event of the AC input voltage. In one example, the switch 126 is turned off by way of the control signal 124. In another example, such as a triac, the switch 126 inherently changes state in response to a brief zero crossing of the current there through.

The non-conductive state of the switch 126 de-couples the circuitry 128 from the node 102, effectively removing it from parallel relationship with the power supply 116. As such, the impendence circuitry 128 no longer has any effect on the power-factor of the power supply 116, until the next triggering of the switch 126.

The controller 118 continues to monitor the respective signals 120 and 122, and determines an activation or “trigger” time prior to each zero crossing of the AC input voltage at nodes 102 and 104. As the input voltage characteristics or current loading vary over time, the respective activations times vary, as well. The repetitive operation of the switch 126 and the impedance circuitry 128, by virtue of the controller 118, are ongoing during normal operation of the system 100. By virtue of the foregoing, the system 100 can also be considered a power supply 100 that is characterized by lagging power-factor adjustment.

### Illustrative Power Supply

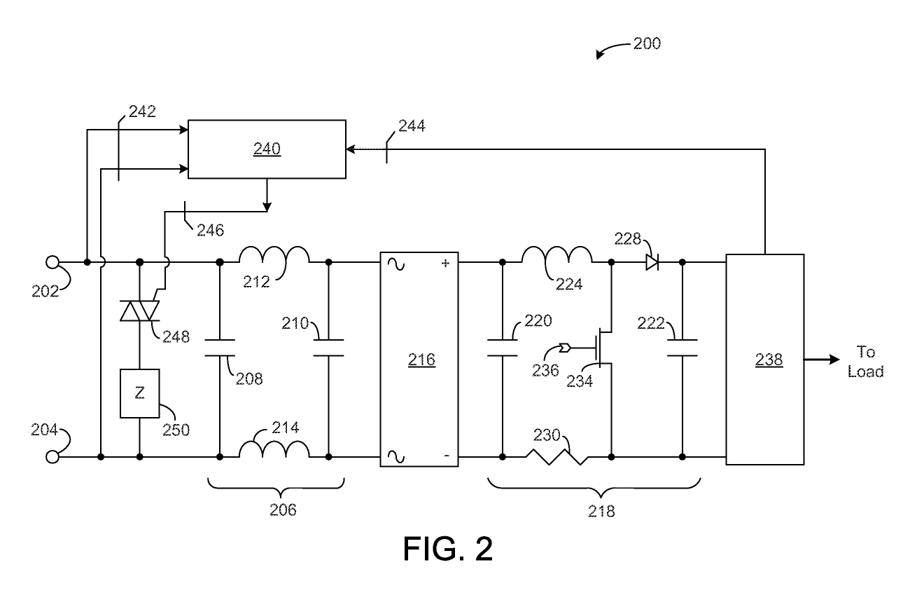

Reference is now directed to FIG. 2, which depicts a power supply 200. The power supply 200 is illustrative and non-limiting in nature. Thus, other power supplies, devices, apparatus and systems are contemplated by the present teachings.

The power supply 200 includes a pair of input nodes 202 and 204, respectively. The input nodes 202 and 204 are configured to be coupled to a source of alternating-current (AC) electrical energy or voltage. Such sources can include, for non-limiting example, a utility line-level source, an on-site generator, a solar energy system, and so on.

The power supply 200 also includes an electromagnetic interference (EMI) filter 206. The EMI filter 206 includes respective capacitors 208 and 210, and respective inductors 212 and 214. The EMI filter 206 receives electrical energy from the input nodes 202 and 204, and is configured to attenuate (or filter) electrical noise that would otherwise be coupled back to the source of electrical energy. In one example, capacitance is the predominant characteristic of the EMI filter 206.

The power supply 200 also includes a full-wave bridge rectifier (rectifier) 216. The rectifier 216 receives electrical energy by way of the EMI filter 206 and provides a fully rectified electrical voltage output. The rectifier 216 can be defined by an integrated circuit (i.e., monolithic) rectifier, a circuit comprised of discrete rectifier diodes, and so on. Other suitable embodiments of rectifier 216 can also be used.

The power supply 200 further includes a power-factor correction boost converter (converter) 218. The converter 218 includes respective capacitors 220 and 222, an inductor 224, a diode 228, a resistor 230, and a power transistor (MOSFET) 234. The MOSFET 234 receives a gate signal input at a node 236.

The converter 218 is further understood to include a control device (not shown) that provides at least the gate signal to the node 236 so as to drive normal operation of the converter 218. One having ordinary skill in the electrical or related arts is familiar with switching-type boost converters, and further elaboration as to the means or method of controlling the converter 218 is not germane to the present teachings.

The converter 218 receives rectified electrical energy from the rectifier 216 and provides (or generates) a direct-current (DC) output of greater voltage than the peak received from the rectifier 216. In particular, the converter 218 derives an increased DC voltage by way of switched energy storage and release through the inductor 224.

The power supply 200 also includes a DC-to-DC voltage regulator (regulator) 238. The regulator 238 receives the increased (i.e., boosted) DC voltage from the converter 218 and provides a conditioned DC voltage output to a load. Non-limiting examples of such conditioning include constant-voltage regulation, current limiting, and the like. The regulator 238 can perform other types of electrical energy conditioning, as well. In one example, the regulator 238 is defined by a monolithic voltage regulator as available from numerous commercial sources. Other regulators 238 can also be used.

The power supply 200 also includes a controller 240. The controller 240 can include or be defined by, without limitation, a microprocessor, a microcontroller, a state machine, digital or analog or hybrid circuitry, an application-specific integrated circuit (ASIC), and so on. Other constituency can also be used. In one example, the controller 240 is equivalent or analogous to the controller 300 described hereinafter. The controller 240 is configured to receive a signal 242 representing an AC input voltage at the nodes 202 and 204. The controller 240 is also configured to receive a signal 244 from the regulator 238 representing a current loading of the power supply 200.

The controller 240 is further configured to determine respective activation times for adjusting the power-factor of the power supply 200. Specifically, the controller 240 uses the sensed signals 242 and 244 to determine when to enable impedance circuitry so as to cause an overall lagging power-factor for the power supply 200. The controller 240 is additionally configured to provide or assert a control signal 246 in accordance with the determined activation times.

The power supply 200 also includes a TRIAC 248 and impedance circuitry (circuitry) 250. The TRIAC 248 is a bidirectional thyristor device that is triggered into an electrically conductive state by way of the signal 246. The TRIAC 248 is also referred to as a switch or switching element for purposes of the present teachings. The TRIAC 248 is configured to electrically couple the circuitry 250 to the node 202 in response to the control signal 246. The TRAIC 248 assumes an electrically non-conductive state during a zero crossing of the AC current there through. Thus, the TRIAC 248 is switched “on” by way of a brief assertion of the control signal 246, and switches “off' as an inherent response to below-threshold current flow there through.

The circuitry 250 is coupled to the TRIAC 248 and to the node 204. The circuitry 250 is characterized by electrical impedance (“Z”) by virtue of one or more electrically reactive elements. In one example, the circuitry 250 is predominantly inductive in character. The circuitry 250 can be defined by any suitable electrical circuitry defined and configured in accordance with the particular characteristics of the rest of the power supply 200 and the desired lagging power-factor. In one example, the circuitry 250 is equivalent to the impedance circuitry 400 described hereinafter.

Typical, normal operations of the power supply 200 are generally as follows: AC electrical energy is received from a source at the nodes 202 and 204. The AC electrical voltage is characterized by a sine-wave frequency of, for non-limiting example, 50 Hertz or 60 Hertz.

The power supply 200 filters (i.e., 206) and rectifies (i.e., 216) this electrical energy, boosts the voltage by switching conversion (i.e., 218), and provides conditioned electrical energy (i.e., 238) to a load entity or entities. The controller 240 monitors the respective signals 242 and 244, and determines when to activate the impedance circuitry 250. Specifically, the controller 240 determines a respective time before each zero crossing of the AC input voltage at the nodes 202 and 204, and asserts the control signal 246 accordingly.

The assertion of the control signal 246 causes the TRIAC 248 to assume an electrically conductive state, coupling the circuitry 250 to the input node 202 and into parallel circuit relationship with the rest of the power supply 200. The electrically reactive characteristics of the circuitry 250 cause the overall power-factor to be lagging in nature (current lags voltage).

The state of the TRIAC 248 then resumes an electrically non-conductive state at some time just after each zero crossing event of the AC input voltage. This non-conductive state de-couples the circuitry 250 from the node 202, effectively removing it from parallel relationship with the rest of the power supply 200. As such, the impendence circuitry 250 no longer affects the power-factor of the power supply 200, until the next triggering of the TRIAC 248.

The controller 240 continues to monitor the respective signals 242 and 244, determining an activation or “trigger” time prior to each respective zero crossing of the AC input voltage. As the input voltage or current loading vary over time, the respective activations times vary, as well. Such repetitive lagging power-factor adjustment/correction is ongoing during normal operation of the power supply 200.

### Illustrative Controller

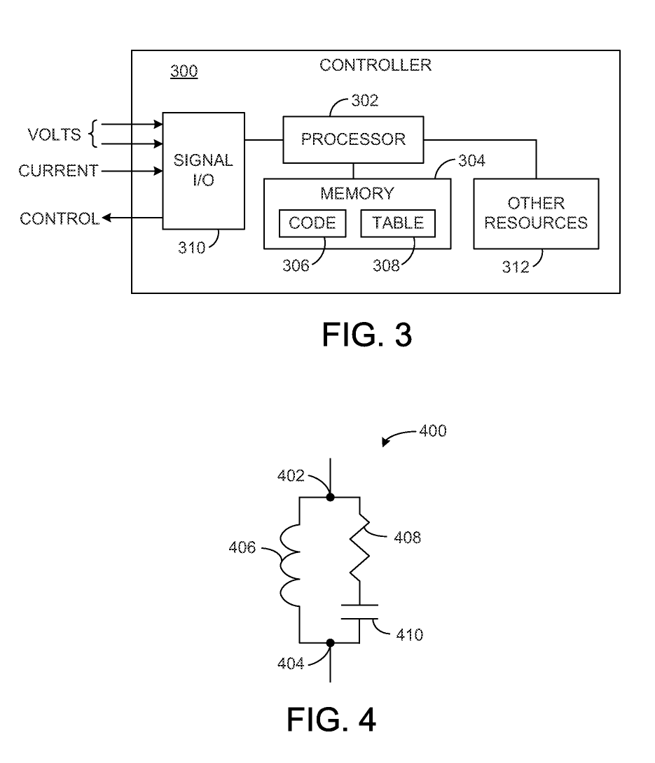

Attention is now turned to FIG. 3, which depicts a controller 300. The controller 300 is illustrative and non-limiting with respect to the present teachings. Other controllers, devices, constituencies or configurations can also be used.

The controller 300 includes a processor 302 configured to operate in accordance with a machine-readable program code. The processor 302 can be defined by any suitable microprocessor, microcontroller, or the like. The controller 300 also includes a processor-accessible storage media (memory) 304. The memory 304 includes a machine-readable program code 306 configured to cause the processor 302 to perform various normal operations.

The memory 304 also includes a data table 308. The data table 308 includes a plurality of correlated AC voltage values, load current values and activation times. The processor 302 can access the data table 308 and determine (i.e., read, interpolate or extrapolate) activation times for adjusting a power-factor of a power supply (e.g., 200) in accordance with the program code 306.

The controller 300 also includes signal input/output conditioning circuitry (signal I/O) 310. The signal I/O 310 is configured to receive a voltage signal (VOLTS) and current loading signal (CURRENT) and to provide digitally quantified representations of these signals to the processor 302. The signal I/O 310 is also configured to receive digital signaling from the processor 302 and to provide a corresponding control signal (CONTROL) output. The signal I/O can include any suitable resources such as analog circuitry, amplifying or buffering circuitry, analog-to-digital (ADC) or digital-to-analog (DAC) conversion circuitry, and so on. Other resources can also be used.

The controller 300 further includes other resources 312. The other resources 312 can include any suitable or required constituency in order to perform normal, typical operations of the controller 300. Such other resources can include, without limitation, a user interface, a network or computer communications interface, power conditioning circuitry, and so on.

The controller 300 is configured to receive signals regarding instantaneous operations of a power supply (e.g., 200) and to provide a control signal to activate impedance circuitry (e.g., 250). A lagging power-factor for a corresponding power supply is realized by way of the normal operations of the controller 300.

### Illustrative Impedance Circuitry

Attention is now directed to FIG. 4, which depicts a schematic diagram of impedance circuitry (circuitry) 400. The circuitry 400 is illustrative and non-limiting in nature. Other impedance circuits, devices and systems, and their respective electrical characteristics, are also contemplated.

The circuitry 400 includes or is defined by a first node 402 and a second node 404. The circuitry 400 also includes an inductor 406 connected between the first and second nodes 402 and 404, respectively. In one example, the inductor 406 is characterized by an inductance of 200.0 milliHenries. Other suitable inductors can also be used.

The circuitry 400 also includes a resistor 408. In one example, the resistor 408 is characterized by a resistance of 2000.0 Ohms. Other suitable resistors can also be used. The circuitry 400 further includes a capacitor 410. In one example, the capacitor 410 is characterized by a capacitance of 200.0 nanoFarads. Other suitable capacitors can also be used. The resistor 408 and the capacitor 410 are connected in series circuit relationship between the nodes 402 and 404. Thus, the resistor 408 and the capacitor 410 are in series arrangement with each other, and in parallel circuit relationship with the inductor 406.

The circuitry 400 defines electrical impedance (that is, having reactive characteristics) that is predominantly inductive. The circuitry 400 can be switchable activated in accordance with the present teachings such that an associated power supply exhibits an overall lagging power-factor.

### Illustrative Method

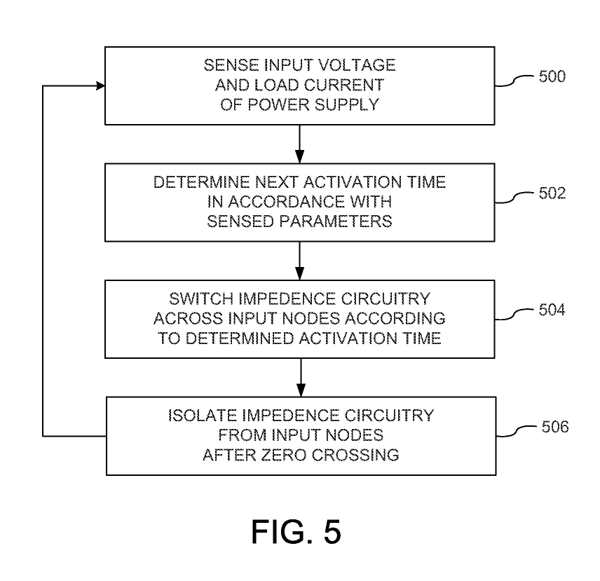

Attention is now directed to FIG. 5, which depicts a flow diagram of a method according to another example of the present teachings. The method of FIG. 5 includes particular steps and proceeds in a particular order of execution. However, it is to be understood that other respective methods including other steps, omitting one or more of the depicted steps, or proceeding in other orders of execution can also be used. Thus, the method of FIG. 5 is illustrative and non-limiting with respect to the present teachings. Reference is also made to FIGS. 2 and 3 in the interest of understanding the method of FIG. 5.

At 500, input voltage and load current of a power supply are sensed. For purposes of a present example, a power supply 200 includes a controller 240. The controller 240 senses an input voltage (or representative signal) 242 and a load current (or representative signal) 244.

At 502, a next activation time is determined in accordance with the sense parameters. For purposes of the present example, the controller 240 determines an activation time for impedance circuitry resulting in a lagging power-factor for the power supply 200. This determination can be made, for non-limiting example, by way of accessing values in lookup table 308 calculating a resultant time value, or a voltage value (which corresponds to a time value). Other determination schema can also be used. The next activation time is just prior to a next zero crossing of the AC input voltage to the power supply 200.

At 504, the impedance circuitry is switched across input nodes of the power supply in accordance with the determined activation time. For purposes of the present example, the controller 240 asserts or pulses a control signal 246 so as to trigger a TRIAC 248 into electrical conduction. The signal pulse corresponds to the pre-zero crossing activation time that was just determined at 502 above. Impedance circuitry 250 is now electrically coupled across the input nodes 202 and 204 of the power supply 200, causing a lagging power-factor as a result.

At 506, the impedance circuitry is electrically isolated from at least one of the input nodes after the zero crossing. In the present example, the TRIAC 248 assumes a non-conductive state in response to insufficient “holding current” there through. The impedance circuitry 250 is now effectively isolated from the input node 202 and no longer has any affect of the power-factor of the power supply 200. This completes a power-factor adjustment operation for a single instance, and the method returns to step 500 above in preparation for a next input voltage zero crossing event.

The method above is described as a discrete steps occurring in a sequential order, in the interest of clarity. It is to be understood that various processes or operations of the present teachings can occur contemporaneously or essentially so.

### Illustrative Signal Diagram

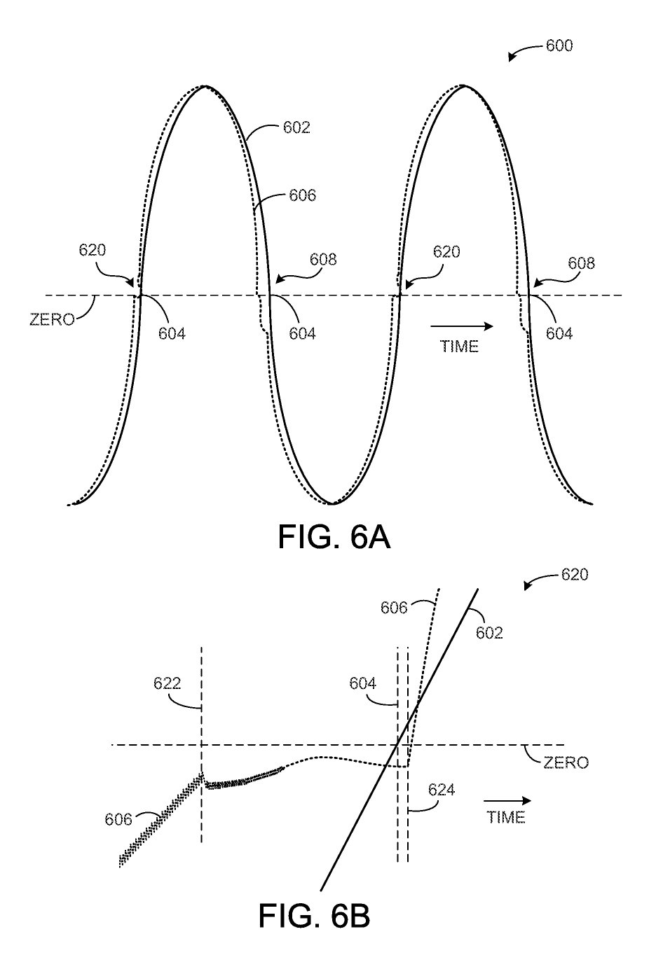

Reference is now made to FIGS. 6A and 6B, which depict a signal diagram 600 and a lagging power-factor event 620 detail diagram, respectively. The diagrams 600 and 620 are illustrative and non-limiting in nature, and are intended to depict general principles germane to the present teachings. Other operating scenarios corresponding to other signal diagrams are also contemplated.

The signal diagram 600 includes an AC voltage 602. The voltage 602 is a characterized by a time-varying sine-wave of (about) constant frequency. The voltage 602 is representative of input voltage to a power supply (e.g., 200) according to the present teachings. The voltage 602 is characterized by a zero crossing event 604 every half-cycle.

The signal diagram 600 also includes an electrical current 606. The current 606 is also time-varying in nature and represents loading of the power supply. The signal diagram 600 depicts leading power-factor events 608 and lagging power-factor events 620, respectively, in the interest of contrasting illustration. However, it is to be understood that typical, normal operations according to the present teachings result in lagging power-factor only.

In a lagging power-factor event 620, the current 606 is on track to lead the voltage 602 through a zero crossing 604, up to a time 622. Impedance circuitry (e.g., 250) is activated at the time 622 by way of switched coupling across the input nodes (e.g., 202 and 204) of the power supply. The reactive characteristics of the impedance circuitry cause an overall lagging power-factor for the power supply. In turn, the voltage 602 zero crossing 604 occurs first in time.

The impedance circuitry is then effectively isolated from the rest of the power supply at a time 624. Isolation is performed by way of switching the impedance circuitry out of contact or coupling with at least one input node (e.g., 202) of the power supply. The current 606 then crosses zero shortly thereafter, lagging in time behind the voltage 602. FIG. 6B depicts general, desired operation under the present teachings.

In a leading power-factor event 608, the current 606 is on track once again to lead the voltage 602 through a zero crossing 604. The impedance circuitry is not activated prior to this zero crossing 604, and a leading power-factor results. This leading power-factor is not desirable, but is depicted in the interest of illustrating lagging power-factor adjustment according to the present teachings.

In general and without limitation, the present teachings contemplate various devices and systems and methods of their use. A power supply includes switching-type voltage boost circuitry and EMI filtering that otherwise result in leading power-factor. A controller monitors input voltage and current loading of the power supply and determines respective activation times for impedance circuitry so to arrive at a lagging power-factor.

The controller provides or asserts a control signal just prior to a voltage zero-crossing event in accordance with a corresponding activation time. The control signal triggers a switching element to couple an impedance (i.e., reactive) circuit into parallel-circuit relationship with the power supply, across the energy receiving input nodes thereof. The impedance circuitry causes the power supply as a whole to exhibit a lagging power-factor, such that the input voltage zero crossing occurs prior to the load current zero crossing.

The switching element effectively removes or isolates the impedance circuitry from the power supply input nodes (or a node thereof) just after the voltage zero crossing event. The impedance circuitry no longer affects the power-factor of the power supply, and the load current zero crosses briefly thereafter. The foregoing scheme is repeated in an iterative manner prior to each discrete zero crossing event, resulting in a lagging power-factor for the power supply.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled.

It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An apparatus, comprising:
circuitry characterized by an impedance;
a switching element configured to electrically couple the circuitry to at least one input node of a power supply in response to a control signal; and
a controller to determine a correction time in accordance with an alternating-current input voltage and a loading of a power supply, the controller to provide the control signal in accordance with the correction time.

2. The apparatus according to claim 1, the circuitry configured to cause a lagging power-factor of a power supply.

3. The apparatus according to claim 1, the switching element configured to electrically isolate the circuitry from the at least one input node after a zero crossing of the alternating-current input voltage.

4. The apparatus according to claim 1, the controller configured such that the correction time corresponds to a next zero crossing of the alternating-current input voltage.

5. The apparatus according to claim 1, the circuitry including at least a capacitor, or an inductor.

6. The apparatus according to claim 1, the circuitry defined by:
an inductor connected between a first node and a second node; and
a resistor and a capacitor connected in series between the first node and the second node.

7. The apparatus according to claim 1, the controller including a computer-accessible storage media, the computer-accessible storage media including data corresponding to alternating-current input voltages and power supply loads and correction times.

8. A power supply, comprising:
a pair of input nodes to be coupled to a source of alternating-current electrical voltage;
circuitry characterized by an impedance, the circuitry configured to cause a lagging power-factor of the power supply;
a switch configured to electrically couple the circuitry to at least one of the input nodes in response to a control signal; and
a controller configured to determine a trigger time in accordance with an input voltage and a current loading of the power supply, the controller configured to provide the control signal in accordance with the trigger time.

9. The power supply according to claim 8, the power supply configured to provide conditioned electrical energy to a load.

10. The power supply according to claim 8, the controller including:
a processor to operate in accordance with a machine-readable program code;
at least one processor-accessible storage media including a program code, the program code configured to cause the processor to determine the trigger time and to provide the control signal.

11. The power supply according to claim 8, the switch configured to electrically isolate the circuitry from the at least one of the input nodes after a zero crossing of the alternating-current electrical voltage.

12. The power supply according to claim 8, the controller configured such that the trigger time is prior to a next zero crossing of the alternating-current electrical voltage.

13. A controller for use with a power supply, the controller configured to determine an activation time in accordance with one or more sensed electrical variables of the power supply, the activation time corresponding to a next zero crossing of an input voltage to the power supply, the controller configured to assert a control signal in accordance with the activation time.

14. The controller according to claim 13, the activation time determined so as to cause a lagging power factor of the power supply.

15. The controller according to claim 13, sensed electrical variable including at least an alternating-current input voltage, or a current loading of the power supply.
